(19) United States
(12) Patent Application Publication
(10) Pub. No.: US 2015/0268798 A1
(43) Pub. Date: Sep. 24, 2015

(54) TOUCH DISPLAY APPARATUS AND TOUCH SENSING METHOD

(71) Applicant: NATIONAL CHIAO TUNG UNIVERSITY, Hsinchu City (TW)

(72) Inventors: Guo-Zhen WANG, Taichung City (TW); Tian-Sheuan CHANG, Hsinchu City (TW); Jen-Hui CHUANG, Hsinchu City (TW)

(73) Assignee: NATIONAL CHIAO TUNG UNIVERSITY, Hsinchu City (TW)

(21) Appl. No.: 14/281,886

(22) Filed: May 19, 2014

(30) Foreign Application Priority Data
Mar. 20, 2014 (TW) 103110522

(51) Int. Cl. G06F 3/042

(52) U.S. Cl. CPC G06F 3/0421

(57) ABSTRACT

A touch display apparatus includes a display panel, a frame and a plurality of sensing modules. The frame is disposed around the display panel and a plurality of apertures is arranged on the frame. The sensing modules are disposed at different height levels respectively. Each sensing module generates sensing data. Each sensing module includes a plurality of sensing units. The sensing units are disposed along the frame respectively and sense light which passes through the apertures. A touch sensing method is also disclosed herein.

### RELATED APPLICATIONS

This application claims priority to Taiwanese Application Serial Number 103110522, filed Mar. 20, 2014, which is herein incorporated by reference.

### BACKGROUND

1. Field of Invention

The present invention relates to a touch display apparatus. More particularly, the present invention relates to a touch display apparatus having sensing modules disposed around a display panel.

2. Description of Related Art

As technologies have rapidly evolved in recently years, various touch sensing technologies are utilized to perceive user input in many electronic products nowadays. Generally, touch sensing technologies can be classified into capacitive sensing, resistive sensing and optical sensing. For resistive sensing, a user input can be obtained according to the pressure of a user pressing a touchscreen. For capacitive sensing, a user input can be detected according to a distortion of a touchscreen's electrostatic field resulted from a user touching a conductive layer coated on an insulation layer (e.g glass) of the touchscreen. For optical sensing, a user input can be detected according to a principle of photo interruption.

However, an effective operation distance for resistive sensing or capacitive sensing is approximately 2 cm (centimeter) from a touchscreen. When a user's finger is away from a touchscreen for more than 2 cm the touch screen (e.g. the touchscreen can be a capacitive or a resistive touchscreen) is unable to detect the user input. In other words, resistive sensing and capacitive sensing cannot provide spatial depth information of the user's finger, so operations of the user's finger in a three-dimensional space cannot be accurately detected. Further, although optical sensing may detect a user operation in a three-dimensional space, optical sensing is limited by an angle of which a light source is captured. When a user is operating in a blind spot (e.g. a position that is close to the touchscreen) an optical touchscreen may be unable to detect the user's operation.

### SUMMARY

The present invention provides a touch display apparatus. The touch display apparatus comprises a display panel, a frame and a plurality of sensing modules. The frame is disposed around the display panel. A plurality of apertures is disposed on the frame. The sensing modules are disposed at different height levels respectively. Each sensing module generates sensing data. Each sensing module comprises a plurality of sensing units. The sensing units are disposed along the frame respectively. The sensing units sense light which passes through the apertures.

An aspect of the present invention provides a touch sensing method for a touch display apparatus. The touch display apparatus comprises a frame and a plurality of sensing modules. The touch sensing method includes steps of: sensing light which passes through a plurality of apertures by sensing modules, wherein the apertures are disposed at different positions of the frame, the sensing modules are disposed at borders of the display panel and the sensing modules are disposed at different height levels so as to sense light variations of different regions in a three-dimensional space; analyzing multiple sensing data sensed by the sensing modules by an algorithm; and obtaining a state of at least an object operating a display panel in the three-dimensional space according to an analysis of the algorithm.

In summary, the touch display device of the present invention comprises a plurality of sensing modules. The sensing modules are disposed at different height levels, so as to sense light variations in different regions in order to determine a state of at least an object in a three-dimensional space.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram illustrating a top view of a touch display apparatus according to an embodiment of the present invention.

FIG. 2 is a diagram illustrating a cross-sectional view of a touch display apparatus according to an embodiment of the present invention.

FIG. 3 is a diagram illustrating a top view of a touch display apparatus according to another embodiment of the present invention.

FIG. 4 is a flowchart illustrating a touch sensing method according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

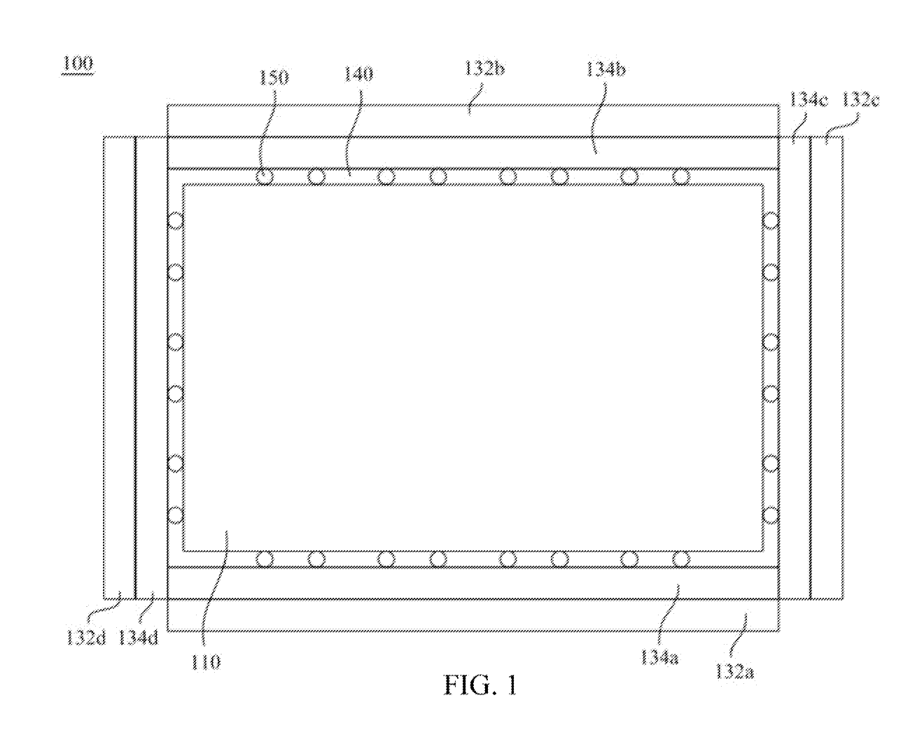

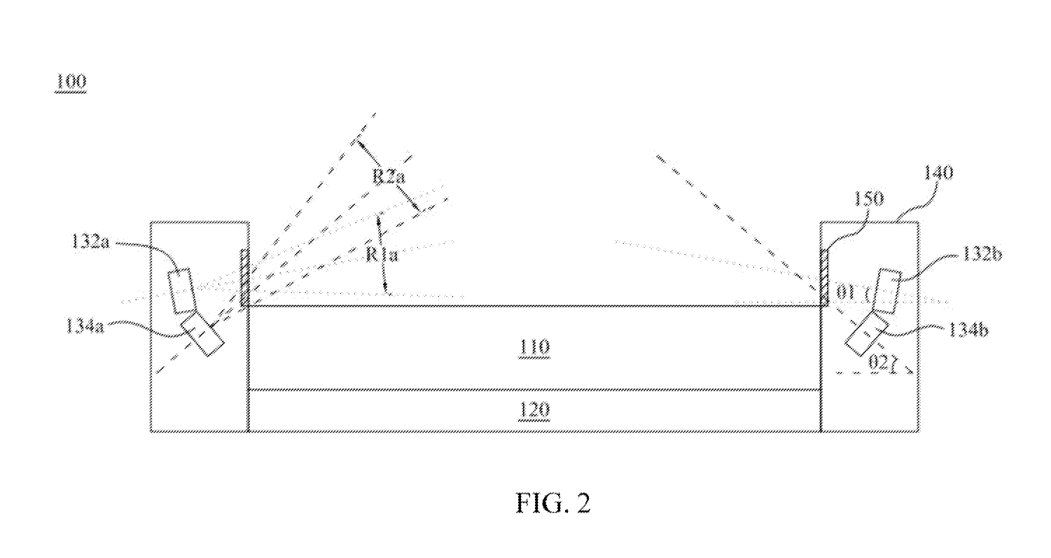

Reference is now made to FIG. 1 and FIG. 2. FIG. 1 is a diagram illustrating a top view of a touch display apparatus according to an embodiment of the present invention. FIG. 2 is a diagram illustrating a cross-sectional view of a touch display apparatus according to an embodiment of the present invention. As shown in FIG. 1 and FIG. 2, the touch display apparatus 100 includes a display panel 110, a backlight panel 120, a first sensing module, a second sensing module and a frame 140.

The display panel 110 is disposed in the middle of the touch display apparatus 100. The display panel 110 can display an image according to a touch operation of a user.

As shown in FIG. 2, the backlight panel 120 is disposed under the display panel 110, in order to generate backlight with high luminance and uniform luminance distribution. The backlight panel 120 can be utilized as a light source for the display panel 110. The backlight panel 120 can be a light-emitting source that is composed with an LED (light-emitting diode) or a light source of any other form.

The frame 140 is disposed along borders of the display panel 110. A plurality of apertures 150 is disposed on the frame 140, so light can pass through the frame 140 via the apertures 150.

The first sensing module can generate sensing data. The first sensing module includes 4 first sensing units 132a, 132b, 132c and 132d. The first sensing units 132a, 132b, 132c and 132d are disposed along borders of the frame 140 respectively as shown in FIG. 1. The first sensing unit 132a is disposed along a lower border of the frame 140, so as to sense the light passing through the apertures 150 disposed on the lower border of the frame 140. The first sensing unit 132b is disposed along an upper border of the frame 140, so as to sense the light passing through the apertures 150 disposed on the upper border of the frame 140. The first sensing unit 132c is disposed along a right border of the frame 140, so as to sense the light passing through the apertures 150 disposed on the right border of the frame 140. The first sensing unit 132d is disposed along a left border of the frame 140, so as to sense the light passing through the apertures 150 disposed on the left border of the frame 140.

As shown in FIG. 1 and FIG. 2, the first sensing units 132a, 132b, 132c and 132d can be plane sensors of a rectangular shape. The first sensing units 132a, 132b, 132c and 132d are tilted along a first axis that passes through the aperture 150s of a respective border of the frame 140, respectively. The first axis has a first angle θ1 with respect to the display panel 110, so the first sensing unit 132a can sense light that has passed through the respective apertures 150 and is within a sensing range R1a. Hence an effective sensing range of the first sensing unit 132a is the sensing range R1a. In other words, when a finger of a user is operating in the sensing range R1a, light received by the first sensing unit 132a varies accordingly, so an action of the user within the sensing range R1a can be obtained.

Similarly, the first sensing unit 132b also has a sensing range so user operations within the sensing range of the first sensing unit 132b can be sensed by the first sensing unit 132b. Each of the first sensing units 132c and 132d also has a respective sensing range.

When a finger of a user hovers to operate the display panel 110, the first sensing units 132a, 132b, 132c and 132d sense variations of spatial luminance and generate sensing data accordingly. An analyzing module (not illustrated) can analyze the sensing data and obtains actions of the user's finger (or fingers) operating the display panel 110 in a three-dimensional space.

Further, since the first sensing units 132a, 132b, 132c and 132d are disposed along the 4 borders of the display panel 110 respectively, actions of a user's finger in a three-dimensional space are unlikely to be blocked by other fingers of the user. Consequently the touch display apparatus 100 of the present invention can accurately sense actions of a plurality of fingers in a three-dimensional space.

The second sensing module also includes 4 second sensing units 134a, 134b, 134c and 134d. The second sensing units 134a, 134b, 134c and 134d are disposed along the borders of the frame 140 as shown in FIG. 1. Arrangements and operations of the second sensing units 134a, 134b, 134c and 134d are similar to those of the first sensing units 132a, 132b, 132c and 132d, so relative descriptions are omitted hereinafter.

As shown in FIG. 2, the second sensing units 134a, 134b, 134c and 134d can be plane sensors of a rectangular shape. The second sensing units 134a, 134b, 134c and 134d are tilted along a second axis that passes through the apertures 150 of a respective border of the frame 140. The second axis has a second angle θ2 with respect to the display panel 110, so the second sensing unit 134a can sense light that has passed through the respective apertures 150 and is within a sensing range R2a. Hence an effective sensing range of the second sensing unit 134a is the sensing range R2a. In other words, when a user's finger is operating in the sensing range R2a, light received by the second sensing unit 134a varies accordingly, so an action of the user within the sensing range R2a can be obtained.

Similarly, the second sensing unit 134b also has a sensing range so user operations within the sensing range can be sensed by the second sensing unit 134b. Each of the second sensing units 134c and 134d also has a respective sensing range.

The first sensing units 132a, 132b, 132c and 132d and the second sensing units 134a, 134b, 134c and 134d are disposed at different height levels, as shown in FIG. 2. The first angle θ1 corresponding to the first sensing nits 132a, 132b, 132c and 132d is different to the second angle θ2 corresponding to the second sensing units 134a, 134b, 134c and 134d. Hence, the first sensing units 132a, 132b, 132c and 132d and the second sensing units 134a, 134b, 134c and 134d can receive light from regions corresponding to different height levels, allowing the touch display apparatus 100 to sense light variations in regions corresponding to different height levels, so as to determine operation actions of multiple fingers of a user in a three-dimensional space.

Although embodiments of the present invention have illustrated the touch display apparatus is operated by a user's finger or fingers) in a three-dimensional space, those skilled in the art can choose another object (e.g. a stylus) to operate the touch display apparatus of the present invention according to practical needs, and is not limited thereto.

Further, although embodiments of the present invention have illustrated the touch display apparatus utilizes two sensing modules, and those skilled in the art can adjust a number of the sensing modules being utilized according to practical needs, and is not limited thereto. For instance, if high sensitivity is desired, more sensing modules can be disposed along the borders of the touch display apparatus, so actions of the user's fingers can be accurately sensed and analyzed.

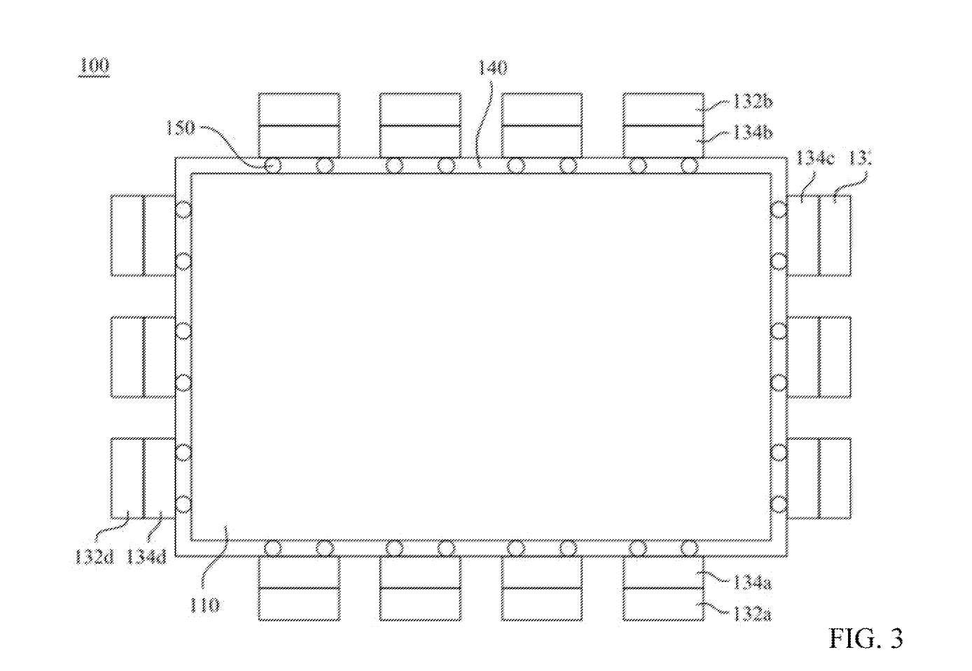

In the above embodiments, sensing units of a sensing module are plain sensors of a rectangular shape, but the sensing units of the present invention are not limited to the above embodiments. The embodiment below describes how light in a three-dimensional space can be sensed by fragment sensors. Reference is now made to FIG. 3. FIG. 3 is a diagram illustrating a top view of a touch display apparatus according to another embodiment of the present invention.

The touch display apparatus 100 of the present embodiment includes a display panel 110, a first sensing module, a second sensing module and a frame 140. The first sensing module and the second sensing module include first sensing units 132a, 132b, 132c and 132d and second sensing units 134a, 134b, 134c and 134d respectively. Arrangements and operations of the first sensing units 132a, 132b, 132c and 132d and the second sensing units 134a, 134b, 134c and 134d are similar to those of the above embodiments, so relative descriptions are omitted hereinafter.

A difference between the present embodiment and the above embodiments is that the first sensing units 132a, 132b, 132c and 132d and the second sensing units 134a, 134b, 134c and 134d are composed by a plurality of fragment sensors respectively. As shown in FIG. 3, each “fragment” of the first sensing units 132a, 132b, 132c and 132d and the second sensing units 134a, 134b, 134c and 134d is arranged to correspond to two apertures 150 of the frame 140 respectively, in order to receive light which passes through the respective two apertures 150.

Further, in the present embodiment, the first sensing units 132a, 132b, 132c and 132d and the second sensing units 134a, 134b, 134c and 134d are disposed at different height levels. The first sensing units 132a, 132b, 132c and 132d and the second sensing units 134a, 134b, 134c and 134d are tilted along a first axis and a second axis respectively. The first axis and the second axis pass through apertures 150 of the respective borders of the frame 140 respectively. The first axis and the second axis has a first angle θ1 and a second angle θ2 with respect to the display panel 110 respectively. The first angle θ1 is different to the second angle θ2. Hence, the first sensing units 132a, 132b, 132c and 132d and the second sensing units 134a, 134b, 134c and 134d can receive lights from regions corresponding to different height levels, allowing the touch display apparatus 100 to sense light variations of regions corresponding to different height levels, so as to determine operation actions of fingers of a user in a three-dimensional space.

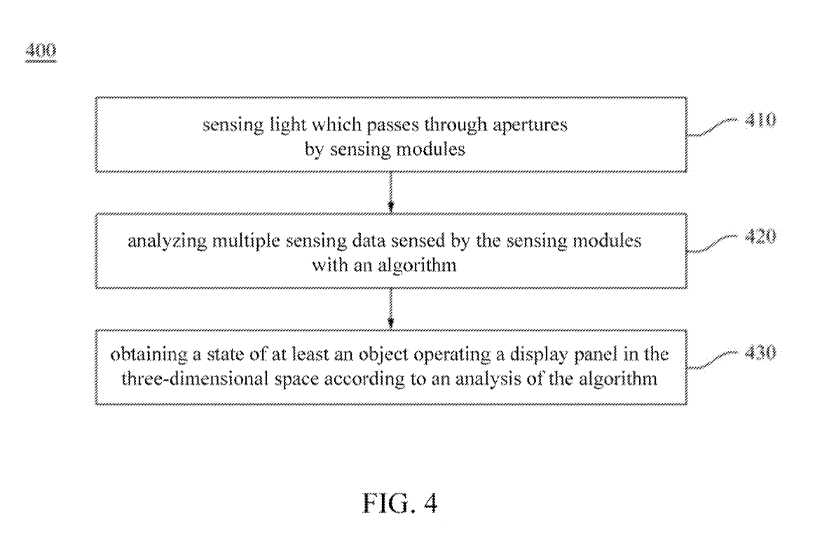

Reference is now made to FIG. 4. FIG. 4 is a flowchart illustrating a touch sensing method according to an embodiment of the present invention. The touch sensing method 400 can be applied to the above embodiments, but is not limited thereto.

The sensing modules are utilized to sense the light which passes through the apertures (step 410). An algorithm is utilized to analyze multiple sensing data sensed by the sensing modules (step 420). A state of at least an object operating the display panel in a three-dimensional space is obtained according to the analysis of the algorithm (step 430).

The apertures are disposed on different positions of the frame. The sensing modules are disposed along the borders of the display panel. The sensing modules are disposed at different height levels respectively, so light variations of different regions in a three-dimensional space can be sensed.

In another embodiment, one of the sensing modules is tilted along a first axis that passes through a respective aperture and the first axis has a first angle with respect to the display panel. Another one of the sensing modules is tilted along a second axis that passes through a respective aperture and the second axis has a second angle with respect to the display panel. The first angle is different to the second angle.

Unless specified otherwise, orders of the steps of the above embodiment can be adjusted, executed simultaneously or partially simultaneously, according to practical needs. The flowchart shown in FIG. 4 is merely an embodiment and is not meant to limit the present invention.

In summary, the touch display apparatus of the present invention can sense a variation of light passing through apertures of the frame via the sensing units disposed around the frame, in order to determine multi-touch operations performed to the touch display apparatus in a three-dimensional space.

Further, sensors of the present invention are disposed along the four borders of the display panel, so a situation of the sensor units being unable to sense correctly due to a user's fingers blocking each other when performing multi-touch operations can be effectively prevented.

Each of the sensor units of the present invention has an angle with respect to the display panel. By incorporating such angles, the touch sensing device can sense light in different height levels above the display panel, so as to analyze actions of a user's finger(s) in a three-dimensional space.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch display apparatus, comprising:
a display panel:
a frame, disposed around the display panel, wherein a plurality of apertures is disposed on the frame; and
a plurality of sensing modules, disposed at different height levels respectively, each sensing module generating sensing data, and each sensing module comprising:
a plurality of sensing units, disposed along the frame respectively, the sensing units sense light which passes through the apertures.

2. The touch display apparatus of claim 1, wherein one of the sensing modules is tilted along a first axis that passes through the aperture, the first axis has a first angle with respect to the display panel, another one of the sensing modules are tilted along a second axis that passes through the apertures, the second axis has a second angle with respect to the display panel, and the first angle is different to the second angle.

3. The touch display apparatus of claim 2, wherein each of the sensing units is a plane sensor of a rectangular shape, disposed along a border of the frame.

4. The touch display apparatus of claim 3, wherein a length of each of the sensing units corresponds to a respective border of the frame.

5. The touch display apparatus of claim 2, wherein the sensing units are composed with a plurality of fragment sensors respectively, and the fragment sensors are disposed according to positions of the apertures.

6. The touch display apparatus of claim 1, further comprising:
an analyzing module, the analyzing module analyzing the sensing data to obtain a state of an object operating the display panel in a three-dimensional space, wherein the sensing modules disposed at different height levels sense light variations in different regions in the three-dimensional space respectively.

7. A touch sensing method for a touch display apparatus, the touch display apparatus comprising a frame and a plurality of sensing modules, the touch sensing method comprising:
sensing light which passes through a plurality of apertures by the sensing modules, wherein the apertures is disposed at different positions of the frame, the sensing modules are disposed at borders of the display panel and the sensing modules are disposed at different height levels so as to sense light variations of different regions in a three-dimensional space;
analyzing multiple sensing data sensed by the sensing modules with an algorithm; and
obtaining a state of at least an object operating a display panel in the three-dimensional space according to an analysis of the algorithm.

8. The touch sensing method of claim 7, wherein one of the sensing modules are tilted along a first axis that passes through the apertures, the first axis has a first angle with respect to the display panel, another one of the sensing modules are tilted along a second axis that passes through the apertures, the second axis has a second angle with respect to the display panel, and the first angle is different to the second angle.
